(19) United States
(12) Patent Application Publication
(10) Pub. No.: US 2011/0029462 A1
(43) Pub. Date: Feb. 3, 2011

(54) METHOD FOR MONITORING DRUG DOSING

(76) Inventor: NIGEL MACRAE, Las Vegas, NV (US)

Correspondence Address: Nigel Macrae, 4709 Compass Bow Lane, Las Vegas, NV, 89130, US

(21) Appl. No.: 12/512,888

(22) Filed: Jul. 30, 2009

(51) Int. Cl. G06Q 90/00; G09F 3/00

(52) U.S. Cl. 705/500; 40/299.01

(57) ABSTRACT

A method and system to assist consumers in monitoring their consumption of acetaminophen or other drugs which may be contained in multiple products from multiple manufacturers. The method consists of scaling each dose on a common scale; printing distinctively on each container the amount one dose of the contained product in scale; instructing the consumer to multiply the number of doses of each product taken by the scaled number for that product; adding all such results together, and then insuring that consumption of the particular drug does not exceed a published number. By using a simple well published scale, having multiple manufacturers agree to using the same scale, and publishing the maximum allowable dose, consumers can easily monitor there consumption of said drug.

### BACKGROUND

Overuse of acetaminophen, also known as N-acetyl-para-aminophenol, is the number one reason for visits to hospitals for pharmaceutical overdosing. Acetaminophen is toxic in large doses, and overdosing of acetaminophen can result in liver damage or kidney damage. Acetaminophen is a drug contained in many over the counter medications as well as prescription drugs and the quantity of acetaminophen per dose is not always disclosed clearly on the packaging. Consumers may not realize how much acetaminophen they are consuming or even that they are getting a dose of acetaminophen when they are taking a dose of any particular medication. Additionally, the consumer may be taking at the same time multiple medications containing acetaminophen. They may be taking other drugs that do not interact well with acetaminophen. Disclosed is an easy system for the tracking and monitoring of consumption of acetaminophen and drugs that interact with acetaminophen, which may also be applied to other drugs or pharmaceuticals.

The process consists of several steps. First, a small number should be selected to represent the maximum dose of acetaminophen during a period, such as six hours. This should be a small integer of 100 or less, and is used as a basis for a scale. For example, 20 may indicate the maximum dose during any six hour period for a full size adult. In the case of acetaminophen this correlates to 1000 mg in six hours. 80 would correspond to 4000 mg, the maximum dose for 24 hours. In this example, a six hour period is used, meaning the top of the scale, 20, represents 1000 mg. 0 represents 0 mg, forming two points of a linear scale. Each package will contain a number calculated from the chosen scale indicating how much acetaminophen is in one dose of that product. For example, if a normal dose of a product containing acetaminophen as an ingredient contains 400 mg of acetaminophen the number 8, indicating 400 mg, shall be printed on the packaging. This number is a scaled representation of a single dose of the enclosed product and shall be clearly printed on each package. Preferably this number includes a distinguishing color or symbol used by all participating manufacturers so that it is easily recognized, and it should also be printed in large type. Different manufacturers will agree to use the same number scale and symbol in representing the quantity of said drug in their product.

Each medicine containing, for example, acetaminophen shall display a message indicating the maximum recommended dose a consumer of the product should take in a period, in this example six hours. In this example that number is 20. A statement stating that, for example, the total from all sources should not exceed 20 in any six hour period shall be placed on the container. Also a chart indicating maximums by weight or age may also be included based on the same scale.

The consumers are instructed to add the scaled number from a container times the number of doses of that product taken to the scaled numbers from every other product taken times the doses of those products taken. This will give them a scaled representation of the total acetaminophen taken. The instructions on the packaging will instruct the consumer not to exceed a maximum, in this example 20 in any six hour period, or risk liver damage and to see a doctor immediately if the recommended dosing is exceeded.

Some drugs should not be mixed with acetaminophen, or the quantity of acetaminophen should be reduced while taking this other drug. A number can be placed on the container which is calculated by using the amount of acetaminophen that has to be reduced when taking this product, for example, alcohol. For example, if the maximum amount of acetaminophen allowed is reduced by 75% for one glass of wine, then 15, representing 75% of the full dose of 20, can be placed with the medicine, indicating in this example that 1500 mg of acetaminophen should not be consumed, and the maximum permitted in that period is 500 mg.

A unique symbol can be placed on each box indicating that the number inside the symbol indicates the scaled dosage and that all manufacturers with this symbol are using the same scale. The symbol should be unique and consistent amongst the manufacturers. For example, the symbol could be a number inside an orange circle or triangular symbol similar a yield sign.

A consumer should easily know the amount of that drug being consumed by adding the scaled quantity of doses taken times the number off the packaging of each item being consumed. This should allow the consumer to closely watch his consumption of acetaminophen so as to not risk liver damage. This same technique will work for other drugs as well, each using a different shared symbol.

### SUMMARY OF THE INVENTION

The disclosed invention is a method to simplify the self monitoring of acetaminophen use. The system consists of 1) using a scaled number to represent the quantity of acetaminophen in a dose of a particular product, said number to be small so as to simplify the addition and multiplication process 2) sharing said same scale with multiple manufacturers so that they all use a consistent scale 3) printing the number representing the amount of acetaminophen in one dose on the enclosed product also showing a distinguishing mark, symbol or color along with large type so that this number is easily found and identified, 4) providing instructions on how to add doses and providing a number not to exceed in a specified period.

One goal is to simplify the mathematics so as to make it easier for all users to calculate their total consumption of acetaminophen. By using small numbers the multiplication and addition is made easier. The second goal is visibility. By manufacturers using a special symbol or color along with the number representing the amount of acetaminophen in a particular dose, the quantity of acetaminophen is easily found. Accidental overdosing is prevented by publishing instructions and a table telling a consumer how to prevent overdosing using this system. By manufacturers using the same scale, consumers can get used to the simple scale and look for the symbol on the container.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentality disclosed herein.

FIG. 1 illustrates a method of disclosing and monitoring dosing of a drug over a particular period of time.

FIG. 2 exemplary illustrates a symbol disclosing in scale the amount of one dose of the contents.

FIG. 3 exemplary illustrates a table showing the maximum dosing allowed for each age group in scale.

FIG. 4 exemplary illustrates a table to translate the dosing taken into said scale.

### DETAILED DESCRIPTION OF THE INVENTION

The disclosure relates to a method for helping consumers calculate the amount of a particular drug they have taken during a duration of time and verify they have not exceeded a specified dosage. It consists of various steps as shown in FIG. 1. The first step is to determine the maximum allowable dose M for a human adult in a particular period. In this example for acetaminophen the maximum dose in a six hour period is 1000 mg. 1000 mg can be represented by a number, for example, 20. This number is used to create a scale, where 20 represents 1000 mg, and 0 represents 0 mg. The number representing the maximum adult dose should be a small integer number, particularly 100 or less. Step 2 is to have various manufacturers use the same scale. For step 3, for each product, a number will be calculated using this scale and the following formula

P=R(N*D/M)

where:
P=number printed on the packaging for the particular drug
D=one dose of the enclosed product in mg. For example, the amount of acetaminophen in one pill or capsule
N is the scaled number that is selected to represent the maximum allowed dose during the period, in this example 20.
M is the maximum dose allowed in a period, in this case 1000 mg in six hours.
R=rounding formula

The rounding formula should normally round up unless, for example, the resulting P by rounding down is off by less than a small percentage of the standard dose. For example, the number should be rounded up unless the rounded down number is >90% of D/1000 mg. In other words, the number should be rounded up, unless the error by rounding down is an insignificant increase in the total dosing by rounding down. This is to help prevent overdosing.

This number P represents the scaled amount of the drug, for example acetaminophen, in one dose from the specific package

In an example, where the dose in a specific package is 350 mg, the formula results in P=R(20*350/1000). This is equal to P=R(7)=7. If the dose is 375 mg the result is R(20*375/1000)=R(7.5) which=8.

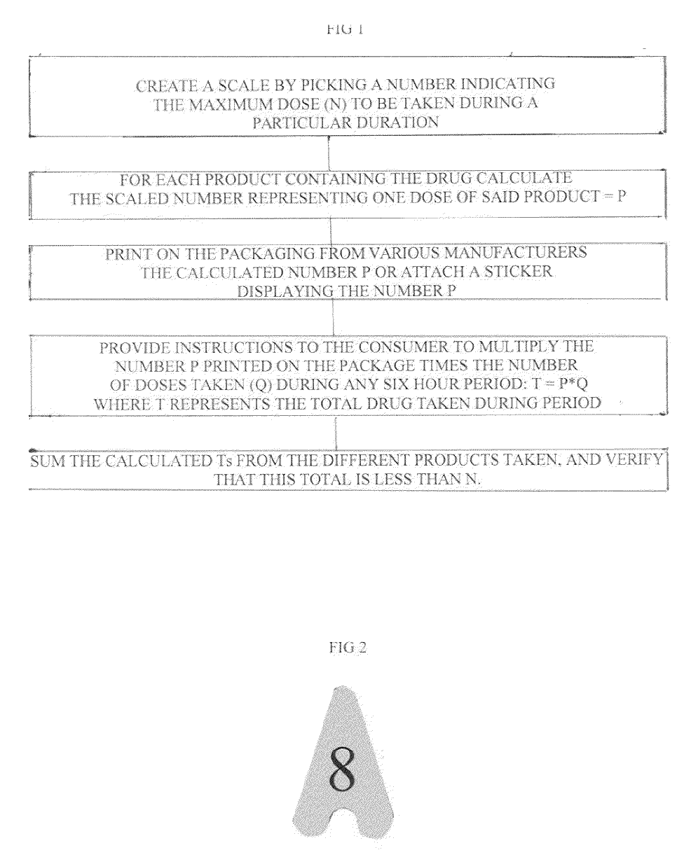

Each drug package will have said number P prominently displayed. This should include the use of the number inside a special symbol like stylized and colored “A”. FIG. 2 displays an example. In step 4 consumers will be instructed by the packaging to add up from each package with the symbol on it the value of the number of P for that container times the number of doses they have taken from each package during said six hour period. They will also be instructed not to have more than a particular maximum in any six hour period. For an adult, in this example, the maximum number is 20. However, a table, for example, may be provided showing by age or weight the maximum dose in a six hour period for children. For a 12 year old child, this number might be 10. FIG. 3 shows the maximum dosing in six hours by various ages.

In the case of dispensed medications, the number P can be printed on a sticker which can be attached to the package at time of dispensing, or printed on the prescription label along with the prescription information.

By summing from every package the number P times the number of doses taken from said package, and comparing this total to the number representing the maximum allowable dosing in any particular period, it will be easy for the consumer to see if he has reached the maximum allowed dose for the specified period. Since in the case of acetaminophen, exceeding the maximum allowed dose for any extended period of time may result in liver damage, the consumer will be instructed to seek immediate medical attention if he exceeds the number representing the maximum allowed dose, and informed that there are things that can be done to reduce the toxicity of an overdose. A special symbol and number, FIG. 2, indicates the presence of the drug in the contents of the package, making it more visible.

This method assists the consumer in determining his taken dose by 1) using a scale with small numbers representing the maximum dose, for example 20 instead of 1000 mg. This allows for easy arithmetic, something that can easily done usually in the head. The consumer will be multiplying and adding small numbers instead of large numbers. Secondly, since the amount of the product in one dose is clearly printed in large type on the packaging of each product usually with a unique mark or symbol, and various manufacturers will use the same symbol and scaled dosing, the dosing can be easily found without reading small print which can be a problem when ill. The maximum to be consumed in a specified period, for example six or 24 hours, shall also be printed clearly on each package. The result is that any consumer will be able to more easily monitor his consumption of the specified drug.

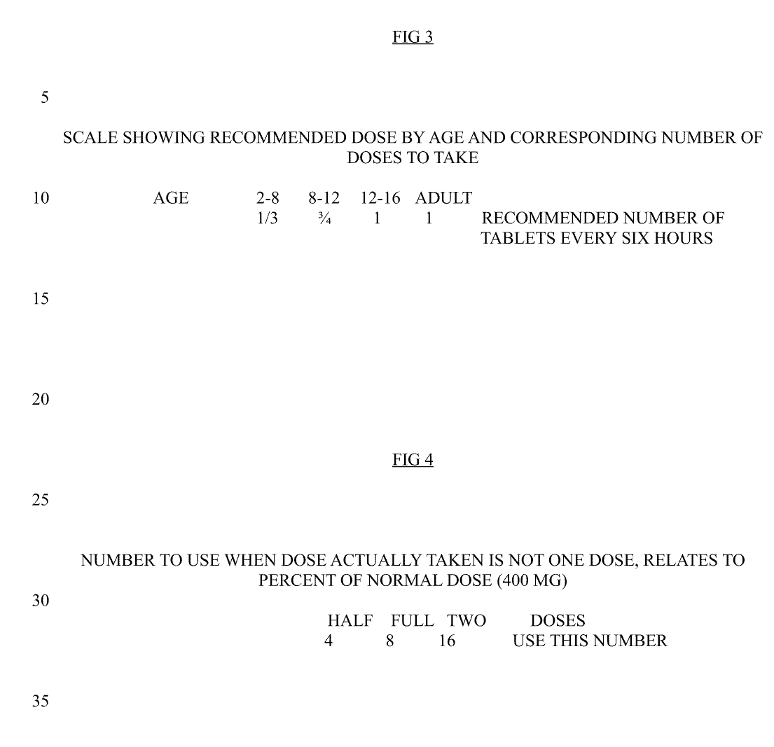

Tables, example FIG. 4, can be provided to put into scale the number of doses which have been taken, which is to be added to the total.

A table of adjustments can be provided if other items are consumed such as alcohol, that will reduce the livers ability to process acetaminophen. For example, each glass of wine can be considered a 15 on the scale. The consumer will have to take a dose of less than 5 (250 mg) when taking a glass of wine to keep the total consumption in six hours to less than 20. If two glasses of wine are taken, no acetaminophen can be taken.

I claim:

1) A method for monitoring the total consumption of a particular kind of drug consisting of a) picking a number, hereafter referred to as N, of 100 or less to represent the recommended maximum dose of said drug for a particular duration for a human adult, b) using said number to create a scale where zero represents zero and said number represents the maximum recommended dose for a particular period c) calculating numbers P for various medicines containing said drug using the formula P=R(N*D/M) where R is a rounding formula, D is the amount of said drug in one dose of the enclosed product, M is the maximum recommended dose in said period d) printing or placing this calculated number P on the packaging of medications containing said drug, d) having various manufacturers with the specified drug component in their medication use the same scale, e) instructing users to add together all of the doses taken times the printed number from different packages and instructing consumers not to exceed a total dosing N during a specific number of hours; so that the consumer can avoid exceeding stated maximum dosage of said drug, thus allowing consumers of said drug to monitor their total consumption of said drug.

2) The claim of 1 further including the use of a special symbol and color within which the calculated number P is placed indicating the relative quantity of said drug in one dose and placing said symbol on the packaging of said drug.

3) The claim of 1 also providing a table in scale with the maximum dosing for one day for different ages or body sizes.

4) The claim of 1 also providing a table in scale with the maximum dosing for a period of time by age or weight.

5) The method of claim one further providing a table of numbers to indicate what to subtract from the total for each hour that has passed since consuming said dose.

6) The method of claim one wherein a specific medication may not contain said drug but represents an effect as if it did contain said drug, whereby a number is supplied with that medication, which represents the effect of that medication on the liver or other organ by displaying a number which represents how much of the monitored drug should be reduced by to compensate for the effect of the medication.

7) The method of claim one further including the placement of the number P on the container of any dispensed drugs as a sticker.
